(19) United States
(12) Patent Application Publication
(10) Pub. No.: US 2022/0117168 A1
(43) Pub. Date: Apr. 21, 2022

(54) System, Method and Apparatus For Condenser Water Reheat

(71) Applicant: STULZ Air Technology Systems, Inc., Frederick, MD (US)

(72) Inventors: Joerg Desler, Frederick, MD (US); David Meadows, Frederick, MD (US); David Athey, Woodsboro, MD (US); Casey McKay, Frederick, MD (US)

(73) Assignee: STULZ Air Technology Systems, Inc., Frederick, MD (US)

(21) Appl. No.: 17/563,328

(22) Filed: Dec. 28, 2021

Related U.S. Application Data
(63) Continuation of application No. PCT/US2020/063914, filed on Dec. 9, 2020.
(60) Provisional application No. 63/073,190, filed on Sep. 1, 2020.
(60) Provisional application No. 62/946,168, filed on Dec. 10, 2019.

(51) Int. Cl. A01G 9/24

(52) U.S. Cl. CPC A01G 9/246

(57) ABSTRACT

An HVAC system for controlling conditions in one or more grow rooms. The HVAC system includes pumps, sensors, controller(s) and valve(s) that mitigate undesired over cooling, which may result in thermally stressing the plants. To counteract the undesired overcooling the HVAC system utilizes reheat to return grow room temperatures to optimal conditions.

### CROSS-REFERENCE TO RELATED APPLICATIONS

This application is a continuation of international Patent Application No. PCT/US2020/063914 (filed on Dec. 9, 2020), which claims the benefit of U.S. Provisional Patent Application Nos. 62/946,168 (filed Dec. 10, 2019) and 63/073,190 (filed on Sep. 1, 2020), the contents of which are hereby incorporated by reference in their entireties.

### BACKGROUND

In general, growing plants in a grow house, such as a controlled environment, utilizes methodologies to enhance the viability of the plants.

There remains a need for devices, systems, and methods to provide improved control of conditions in a grow house to facilitate the growth and production of healthy, harvestable plants. This need is particularly important to improve food production in the world. Improved control of temperature and moisture conditions in grow houses can reduce the distance which food is transported during the journey from producer to consumer (“food miles”). The lower the food miles, the cheaper the food is to the consumer. The economic savings of producing food according to the embodiments described herein reduces the energy needed to heat grow houses and also reduces the carbon footprint of food production.

### BRIEF DESCRIPTION OF THE DRAWINGS

The accompanying drawings provide visual representations, which will be used to more fully describe various representative embodiments and can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals may identify corresponding elements.

FIG. 1 illustrates a block diagram of an expansion air conditioner-dehumidifier system, in accordance with an embodiment of the present disclosure.

FIG. 2 illustrates schematic diagram of a CWR (condenser water reheat) system, in accordance with an embodiment of the present disclosure.

FIG. 3 illustrates a pressure-enthalpy diagram of a refrigeration cycle, in accordance with an embodiment of the present disclosure.

FIG. 4 illustrates a psychrometric chart, according to an embodiment of the present disclosure.

FIG. 5 illustrates an example of airflow, according to an embodiment of the present disclosure.

FIGS. 6A and 6B illustrate an example of a state point and process report, according to an embodiment of the present disclosure.

FIG. 7 depicts a refrigerant loop, in accordance with an embodiment of the present disclosure.

FIG. 8 shows a thermal energy transfer loop 800, in accordance with an embodiment of the present disclosure.

FIG. 9 shows an embodiment of an airflow path according to an embodiment of the present disclosure.

FIG. 10 depicts energy flow diagram 1000, according to an embodiment of the present disclosure.

### DETAILED DESCRIPTION

The various methods, systems, apparatus, and devices described herein generally provide for a novel approach to control of grow rooms in a humidifier or humidifier systems.

In general, the devices, systems, and methods described herein provide control of a grow house, also referred to as a grow space herein, particularly the control of temperature and humidity conditions in the grow space.

Embodiments of the present disclosure have application in vertical farming, which permits growth of plants/crops in vertically stacked layers. Embodiments are also directed to use of the apparatus, method and system to hydroponics, aquaponics, aeroponics and the like.

Additionally, the grow house, or grow space conditions as described herein provide beneficial environments for cultivation of micro greens as well as grains. As described herein, the use of the novel processes significantly reduces the amount of energy required to produce plants and/or crops. This reduction of energy reduces the carbon footprint of food production.

Maintaining proper and desirable conditions within a number of different grow rooms, or grow spaces, is a challenge. Not only is it desirable to often maintain different temperature and moisture conditions during the different phases of the plant's lifecycle (clone, vegetative, flowering, drying, and storage) there are often different conditions that should be maintained in both “lights on” and “lights out” operations.

During the lights on stage it is typical to see the highest sensible heat load (provided by the lighting) and the highest latent load as the plants transpire moisture in a vapor form into the air. This occurs substantially simultaneously with natural evaporation from moist earth or grow medium, standing water on grow tables, or open drains.

The combination of transpiration and evaporation is known as evapotranspiration and it is the function of the HVAC (heating ventilation air conditioning) equipment to remove a desired portion of the moisture from the air to decrease the relative humidity in the air.

This is an important function since high moisture content in the grow space can lead to the rapid formation of white mold and mildew. The growth of mold or mildew is undesired since such growth can reduce a crops value significantly, and in worst case situations the entire crop can be rendered useless.

An opportune time to combat the formation of mold and mildew on the plants is during the lights out or “nighttime” period. During this time evapotranspiration continues at a reduced rate but this moisture must continue to be removed to prevent, or reduce, the formation of mold or mildew on the plants.

Dehumidification is useful to ensure that mold, mildew, and rot do not damage the plants. During dehumidification, the air is cooled down to the dew point where moisture is then stripped out on a cooling coil to prevent excessive moisture content in the grow space.

Often times the dew point temperature is well below the desired room temperature and some type of reheat is required to raise up the HVAC unit leaving air temperature so as not to thermally shock the plants. This reheat can take many forms such as hot gas reheat, electric reheat, hot water and low-pressure steam reheat.

Without the heat input from the grow lights the temperatures in the grow space will continue to fall as the HVAC units continue to run to strip unwanted moisture from the grow space, by decreasing the temperature and thereby decreasing the humidity. This over cooling may result in thermally stressing the plants or worse.

To counteract this overcooling by the HVAC units, some form of reheat must be utilized to return the grow room temperatures to optimal conditions.

These reheat types can be used effectively but have some additional expenses associated with them.

The novel CWR (condenser water reheat) system, as described herein, can provide 100% reheat capacity at no additional operating costs. This system is also referred to as an expansion air conditioner-dehumidifier system.

The recycled hot water reheat system described and shown herein is a novel approach to eliminate the use of electric reheat elements and the large operating expenses associated with this form of reheat. This novel approach can be described as a CWR system.

As described herein, the novel CWR system, which may also be described as an expansion air conditioner-dehumidifier system, is at least a portion of a water-cooled direct expansion environmental control system for plant growing systems, such as cannabis grow facilities or other grow house environments. This may also be described as a direct thermal expansion air conditioner/dehumidifier system. This system is generally a thermal energy transfer system.

The novel CWR system is designed to reduce power consumption and decrease the money spent per volume, mass (gram) of plant product, or cannabis, produced. This decrease in money spent per unit of plant product produced increases the profitability, or return on investment (ROI), of the plant growing system.

The novel CWR system includes thermal expansion air conditioner/dehumidifier that is supplied with one or more condenser water or “recycled” reheat coils and a hot water control valve, which may be a precision hot water control valve. This enhances desired thermal energy transfer characteristics.

During dehumidification, which results in overcooling, a temperature sensor downstream of the pumps sends a temperature signal to a controller which in turn positions a valve, such as a three way valve, to either send water to the fluid coolers (temperature above setpoint) or bypasses the fluid coolers (temperature below set point) or to some position in between where a portion of the flow is bypassing the fluid coolers and some of the flow is directed to the fluid coolers to maintain water temperature set point prior to entering HVAC systems.

The water entering the expansion air conditioner-dehumidifier system for a grow space system first enters the refrigerant condenser where the refrigerant evaporator removes (i.e., absorbs) the latent heat of vaporization from the refrigerant. A head pressure control valve, which regulates that flow rate, is controlled by the refrigerant pressure inside the refrigerant condenser.

As much as 100% of the water that was originally controlled to the set point by the temperature control valve and further heated in the condenser is made available to the three-way temperature control valve. The three-way temperature control valve modulates the flow of hot water to the recycled reheat coil that is located in the HVAC unit to accurately control grow room temperature allowing for constant dehumidification without utilizing additional forms of heat energy thus saving power and money.

More specific descriptions in relation to the figures is provided herein.

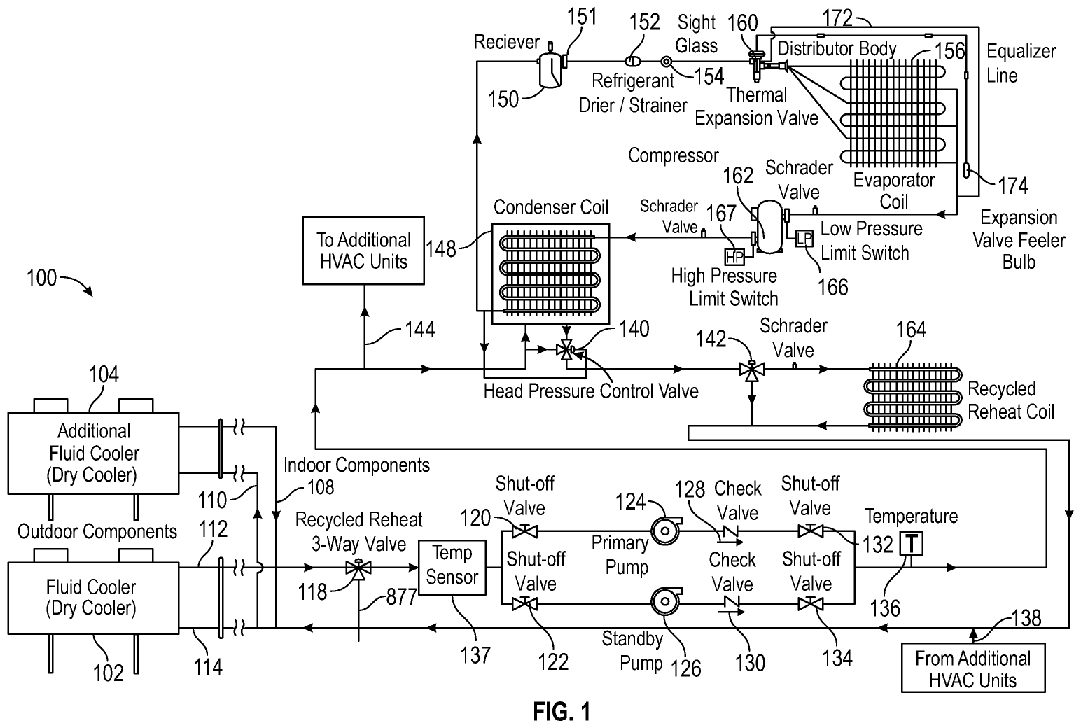

FIG. 1 illustrates a block diagram of expansion air conditioner-dehumidifier system 100, in accordance with an embodiment of the present disclosure.

Generally, system 100 includes one or more condensers or condenser coils 148, one or more recycled reheat coils 164, and one or more evaporators or evaporator coils 156 that not only cool and dehumidify the incoming air using a refrigerant loop, but also reheat the cool and less humid air using the latent heat of vaporization of the refrigerant captured by a separate thermal energy transfer loop.

Within the refrigerant loop, condenser coil 148 is coupled to receiver 150 and high pressure limit switch 167. Receiver 150 is coupled to thermal expansion valve 160 through sight glass 154, strainer 152 and service valve 151. Evaporator coil 156 is coupled to low pressure limit switch 166 and to thermal expansion valve 160, and may also be coupled to equalizer line 172 and expansion feeder bulb 174. Compressor 162 is coupled to low pressure limit switch 166 and high pressure limit switch 167, which monitor and control the amount of refrigerant that is provided to compressor 162. Generally, the refrigerant loop uses a refrigerant.

Within the thermal energy transfer loop, fluid coolers 102, 104 are coupled to condenser coil 148 and recycled reheat coil 164 through three-way valve 118, shut-off valves 120, 122, 132, 134, pumps 124, 126, check valves 128, 130, temperature sensors 136 and 137, line(s) from additional HVAC units 138, line(s) to additional HVAC units 144. Condenser coil 148 is coupled to recycled reheat coil 164 through three-way valves 140, 142. Generally, the thermal energy transfer loop uses a “fluid” that is a liquid (e.g., water), but, in certain embodiments, a fluid may be a mixture of two or more liquids, a gas, or a combination of a liquid and a gas.

Pumps 124, 126 are configured to pump a flow of fluid. This fluid may be supplied from water tanks, or other source of fluid, such as a well, pond, suitable container or tank. A controller (not shown for clarity) may be operatively coupled to at least one of the one or more pumps 124, 126, and may be a microprocessor, CPU, electronic processor, etc. One or more valves 118, 140, 142 are operatively coupled to the controller. The valves 118, 140, 142 can be three-way valves. One or more fluid coolers 102, 104, also referred to as dry coolers, are coupled to the valves 118, 140, 142 and pumps 124, 126 via lines 108, 110, for cooler 104, and lines 112 and 114 for cooler 102.

A temperature sensor 136 is disposed downstream of the one or more pumps 124, 126, the temperature sensor configured to send a temperature signal to the controller. The controller is configured to control the valves 118, 140, 142, operated alone or in concert, to:
send fluid to the fluid coolers 102, 104; or
bypasses the fluid coolers 102, 104; or
set the valves 118, 140, 142 to some position in between where a first portion of the flow of fluid is bypassing the fluid coolers 102, 104 and a second portion of the flow of fluid is directed to the fluid coolers 102, 104 thereby maintaining a desired water temperature.

Temperature sensor 137 is disposed upstream of the shut off valves 120, 122. Temperature sensor 137 may be operated in conjunction with temperature sensor 136.

Certain embodiments of system 100 set the desired fluid (e.g., water) temperature prior to the fluid entering the system. In these embodiments, the controller programs or controls the temperature sensor 136 and pumps and valves to circulate the fluid to the various elements of the system 100.

The thermal energy transfer fluid may be water, glycol, a glycol/water mixture, etc. The fluid from the check valves 128, 130 and shut-off valves 132, 134 is monitored by temperature sensor 136. The fluid is then provided to additional HVAC units 144 as well as to condenser coil 148 and/or head pressure control valve 140. A return path through the recycled reheat coil 164 provides fluid back to the fluid coolers 102, 104, which may also include energy from additional HVAC units 138.

As shown in FIG. 1, the flow path of the fluid starts at the fluid cooler 102, 104, as shown by lines 108 and 112, and, after valves 118, 120, 122 and pumps 124, 126, check valves 128, 130 and shut-off valves 132, 134, the temperature of the fluid is checked at temperature sensor 136, and the fluid is then provided to condenser coil 148. The fluid may also be provided to other HVAC units via line 144.

After the condenser coil 148, the fluid is provided to recycled reheat coil 164 for the reheat process. The fluid is then returned to the fluid coolers 102, 104. The fluid returned to fluid coolers 102, 104 may also include fluid from additional HVAC units show generally as 138. Head pressure control valve 140 is configured to regulate a flow rate that is controlled by fluid pressure inside condenser coil 148.

In another embodiment, valve 142 modulates the flow of hot fluid to recycled reheat coil 164 to accurately control grow room temperature allowing for constant dehumidification independent of additional forms of heat energy.

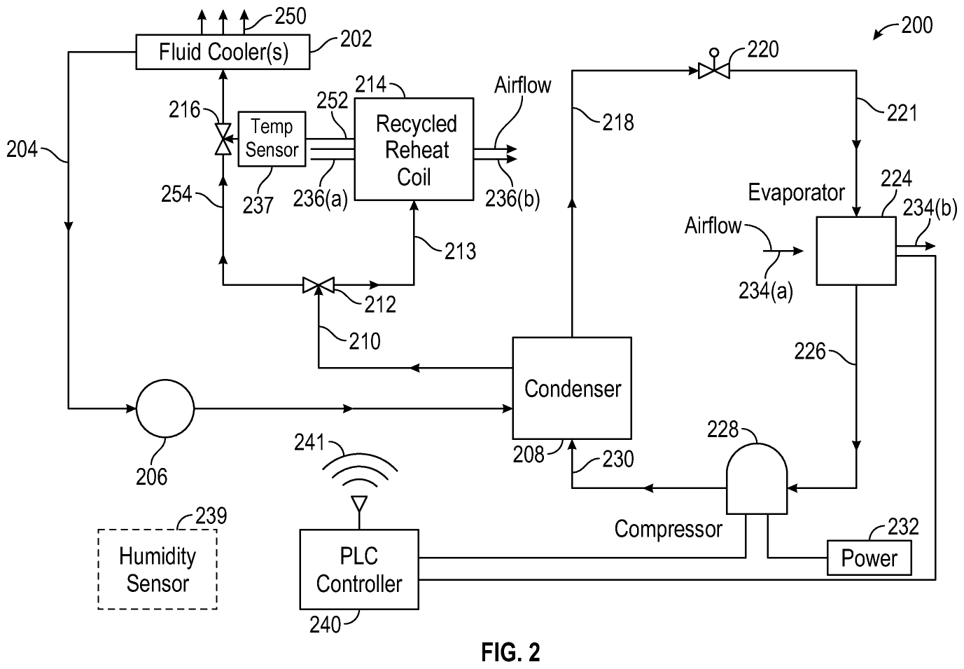

FIG. 2 illustrates a schematic diagram of a CWR system 200, in accordance with an embodiment of the present disclosure.

System 200 includes one or more fluid coolers 202, fluid source 206, condenser 208, recycled reheat coil 214, evaporator 224, compressor 228, valves 212, 216 and 220, electrical energy source 232, temperature sensor 237, and controller 240.

The system 200 can be described as two loops: a refrigerant loop and a thermal energy transfer loop. In addition to the two loops, airflow may be used to affect the temperature.

The refrigerant loop includes condenser 208, control valve 220, evaporator 224 and compressor 228. The selection of refrigerant is a function of desired design parameters.

The thermal energy transfer loop includes fluid coolers 202, fluid source 206, condenser 208, control valve 212, recycled reheat coil 214, and temperature sensor 237.

In addition to the refrigerant loop and thermal energy transfer loop, airflow 236(a) and 236(b) interacts with recycled reheat coil 214 and the airflow 234(a) and 234(b) interacts with evaporator 224. Thus, the airflows 234 and 236 are another fluid flow in addition to the refrigerant loop and thermal energy transfer loop. Ambient air is represented as airflow 234 and 236.

The airflow 234(a) is prior to, or before the evaporator 224 and is not affected by the evaporator 224. The airflow 234(b) is after the evaporator 224 and is affected by passing through the evaporator 224. The airflow 234(b) is cooler air than the ambient air and airflow 234(b) is cooler than airflow 234(a).

Ambient air can also be represented as airflow 236(a) and 236(b).

In a similar fashion as airflow 234, airflow 236(a) is before, or not affected by recycled reheat coil 214. Airflow 236(b) is after or has been affected by recycled reheat coil 214. The airflow 236(b) has a higher temperature than airflow 236(a), since airflow 236(b) has been exposed to recycled reheat coil 214. The airflow 236(b) is provided to the grow room, or grow space, as heated air.

Specifically, as shown in FIG. 2, refrigerant flows from condenser 208, as shown by line 218. The refrigerant flows to control valve 220 and out of control valve 220 to evaporator 224. Air flows through the evaporator 224, as shown by entry airflow 234(a) and exit airflow 234(b). The refrigerant then flows from evaporator 224, as shown by line 226 to compressor 228 and back to condenser 208, as shown by line 230.

Electrical energy, or power, may be supplied by electrical circuit, or power supply, 232. This electrical energy may be provided to compressor 228, or other component of the system 200.

A controller 240, which may be any suitable electronic controller, such as an Electronic Control Unit (ECU) or, Programmable Logic Controller (PLC) provides control signals to compressor 228, condenser (or condenser coil) 208, evaporator (or evaporator coil) 224 or any combination of those elements. These control signals from controller 240, may be transmitted via a wire and/or wireless connection.

The controller 240 has adequate processing power and memory capacity to perform the electronic control of compressor 228 as well as other components in the system 200 (connections not shown). The controller 240 represents one or more computer processors for the system 200.

The thermal energy transfer loop provides for thermal energy transfer utilizing condenser 208, three-way or control valve 212, recycled reheat coil 214, valve 216 and one or more fluid coolers, shown as 202.

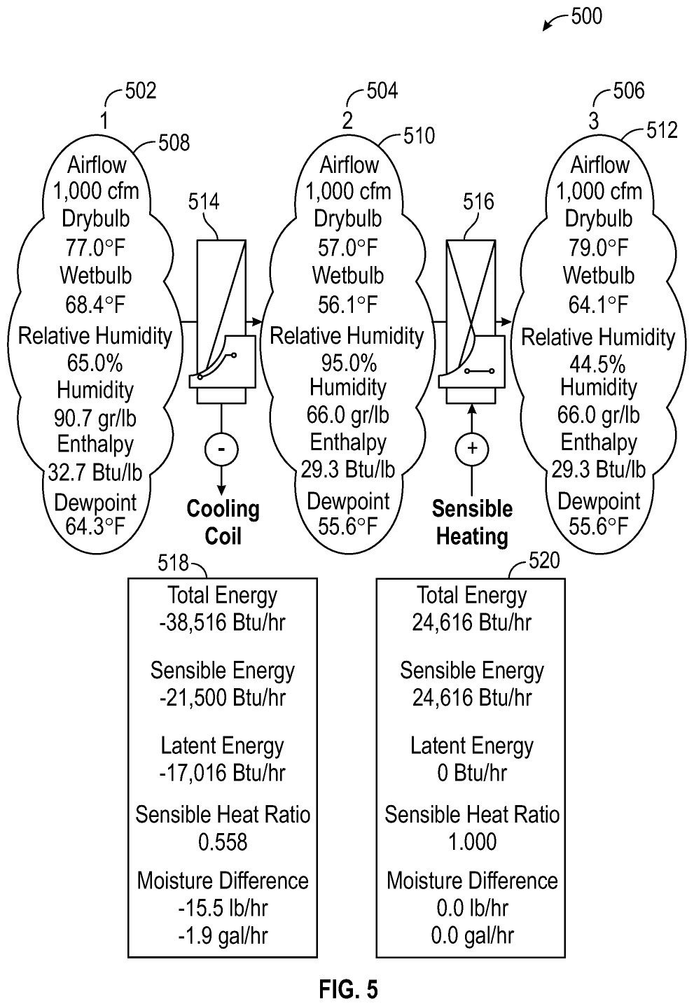

Specifically, a medium, such as water or other fluid, including liquid and/or gas components, which has been received from fluid source 206 to condenser 208, flows from condenser 208 to valve 212, as shown by line 210. The medium, such as water, from valve 212 can flow to recycled reheat coil 214 or to valve 216 in any portion or percentage. The flow control from valve 212 is based, at least in part, on desired thermal and moisture characteristics. The desired temperature can be established by temperature sensor 237. A humidity sensor 239 may be disposed in the grow space. The humidity sensor 239 may be mounted on an interior wall of the grow room, or grow space, and measures moisture content in the grow room, or grow space. The humidity sensor 239 may be a remote sensor that can also be used to sense or detect relative humidity of the ambient air in the grow space. The humidity sensor 239 detects moisture of the ambient air and this moisture is reduced by the condenser coil to inhibit excessive moisture content in the grow space. The excessive moisture is a moisture level that exceeds a desired threshold. The thresholds and levels for latent energy, or moisture content, are provided in more detail in FIG. 5.

One output from valve 212 is input to valve 216. Valve 216 also receives, as input, the output from recycled reheat coil 214. Output from valve 216 is provided to fluid coolers 202. The fluid coolers 202 can remove heat from the water, and then provide the cooled water to fluid source 206 via line 204.

The water from fluid source 206 is provided to condenser 208, which transfers heat from the refrigerant to the water. Airflow 236(a) and 236(b) flows through recycled reheat coil 214.

As stated above, the airflow 234(a) is prior to, or before the evaporator 224 and is not affected by the evaporator 224. The airflow 234(b) is after the evaporator 224 and is affected by passing through the evaporator 224. In a similar fashion as airflow 234, airflow 236(a) is before, or not affected by recycled reheat coil 214. Airflow 236(b) is after or has been affected by recycled reheat coil 214. The airflow 236(b) has a higher temperature than airflow 236(a), since airflow 236(b) has been exposed to recycled reheat coil 214.

The following analysis illustrates the savings of substituting the novel condenser water reheat system as described herein in place of a traditional electric reheat system in a traditional flowering room.

Assumptions:
Cost of power: $0.10 per kW-Hr;
Unit is serving a flower room that cycles between 12 hours light and 12 hours dark;
Dehumidification with reheat only occurs during the lights out cycle;
During the lights out cycle dehumidification takes place during 50% of the cycle;
The room is in grow use 80% of the time with 20% set aside for cleaning and maintenance;
500 plants;
Water rate is 0.5 gallons per plant per day;
Room temperature is maintained at 75° F. (h_{IIg}=1050 BTU/LBM);
Sensible heat ratio during dehumidification is 0.55;
No infiltration nor solar loads; and
70% of water is removed during the lights on cycle.

Calculations:
Hours of dehumidification requiring reheat:
   6 hours/day×365 days/year×0.80=1752 hours per year
Latent load during lights out dehumidification:
   0.5 gallons/day/plant×500 plants=250 gallons per day
   0.3×250 gallons=75 gallons
   75 gallons/6 hours=12.5 gallons per hour of dehumidification
   12.5 gallons per hour×8.34 LBM/gallon×1050 BTU/LBM=109,462
   BTU/Hr=32 kW
Reheat required during lights out dehumidification:
   32 kW/0.45=total cooling=71.3 kW
   71.3×0.55=required reheat=39.2 kW

Operating expense of electric reheat in one year:
1752 hours per year*39.2 kW=68,678 kW-Hrs
144,540 kW-Hrs×$0.10 per kW-Hr=$6,867.00 per year

The operating cost of reheat goes to zero when replaced by the novel CWR condenser water reheat system saving over $68,000 in operating per year in a typical 10 room facility.

Savings will vary with the local cost of electricity.

The CWR system, as described herein, recycles the room's latent and sensible heat load plus the heat of compression of the refrigerant (imparted by the compressor) to raise the room temperature back to set point during dehumidification operations.

Dehumidification in the grow room reduces powdery mildew and rot. To dehumidify the space of the grow room, the environmental control unit reduces the dry bulb temperature to the dew point (sensible cooling). As the temperature approaches the dew point the continued heat removal strips moisture from the air while lowering the dew point (latent cooling). The dew point is a function of the temperature and moisture conditions in the grow room or grow space.

This process often reduces the dry bulb temperature below the desired temperature. In a grow room, this over cooling can thermally shock the plants and lead to unwanted characteristics, reduced grow rate and yield, or result in the death of the plants.

To return the temperature leaving the environmental control unit (ECU) to the set point the condenser water reheat system integral to the ECU is utilized. The condenser water reheat system allows the heat that was removed from the refrigerant in the condenser to be reintroduce to the room through a well-regulated process that reduces the significant cost of electric, steam, or hot water heat.

The system for dehumidification includes an environmental control unit (ECU) equipped with:

Fans, compressors, evaporator coils, water/glycol cooled condensers, thermal or electronic expansion valves, head pressure control valves, condenser water reheat coils, condenser water reheat valves (2 and 3 way valves), and other typical refrigeration support components such as drier strainers, check valves, solenoid valves, receivers, etc.

The ECU is also provided with a programmable logic controller and custom software to control all components during cooling, dehumidifying, and reheating.

In another embodiment, the system is served by pumping system, such as a water and/or glycol pumping system to move the water/glycol from the indoor ECU to the outdoor heat rejection system. This pumping system may be a single pump or multiple pumps, fixed or variable speed pump motors with support components such as triple duty valves, strainers, isolation valves, pressure gauges, pressure transducer, and an electric control panel with a speed/on-off controller.

Yet another embodiment includes a heat rejection system that is preferably located outdoors. This heat rejection system can be a fluid cooler or a closed or open loop cooling tower. In either case a three-way control valve (mixing valve), temperature sensor, and valve controller are used to maintain return water temperature to ensure sufficient heat exists in the fluid to provide the required reheat.

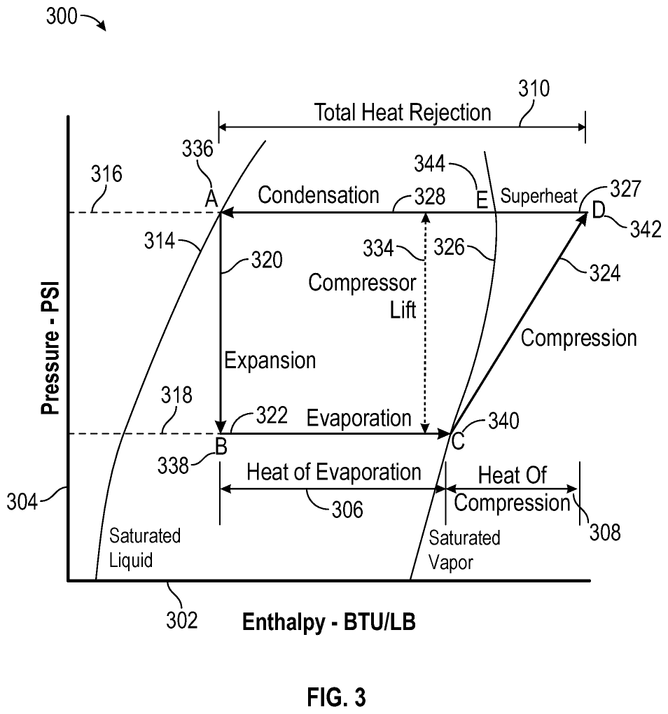

FIG. 3 illustrates pressure-enthalpy diagram 300 of a refrigeration cycle, in accordance with an embodiment of the present disclosure.

X-axis 302 represents enthalpy-BTU/LB and y-axis 304 represents pressure magnitude in PSI (pounds per square inch). Pressure level 316 and pressure level 318 depict two different pressure levels. Heat of evaporation 306, heat of compression 308 and total heat rejection 310 are shown. With respect to the refrigeration cycle, expansion portion 320, evaporation portion 322, compression portion 324, superheat portion 327 and condensation portion 328 are illustrated relative to pressure levels 316 and 318, as well as points “A” 336, “B” 338, “C” 340, “D” 342 and “E” 344. Saturated liquid line 314, saturated vapor line 326 and compressor lift 334 are also shown.

Total heat rejection 310 that extends from point “D” 342 to point “A” 336, heat of evaporation 306 extends from point “B” 338 to point “C” 340, and heat of compression 308 extends from point “C” 340 to point “D” 342. Saturated liquid line 314 extends from x-axis 302 to point “A” 336, and saturated vapor line 326 extends from x-axis 302 to point “E” 344. The region to the left of saturated liquid line 314 represents incompressible liquid refrigerant, the region between saturated liquid line 314 and saturated vapor line 326 represents a mixture of liquid and vapor refrigerant, and the region to the right of saturated vapor line 326 represents compressible vapor refrigerant.

Point “A” 336 is at pressure level 316, as shown on y-axis 304. As pressure decreases to pressure level 318, point “B” 338 is reached. As energy increases, point “C” 340 is reached. As compression increases, point “D” 342 is reached at pressure level 316. As energy is decreased, point “E” 344 is reached first, and then point “A” 336 is reached.

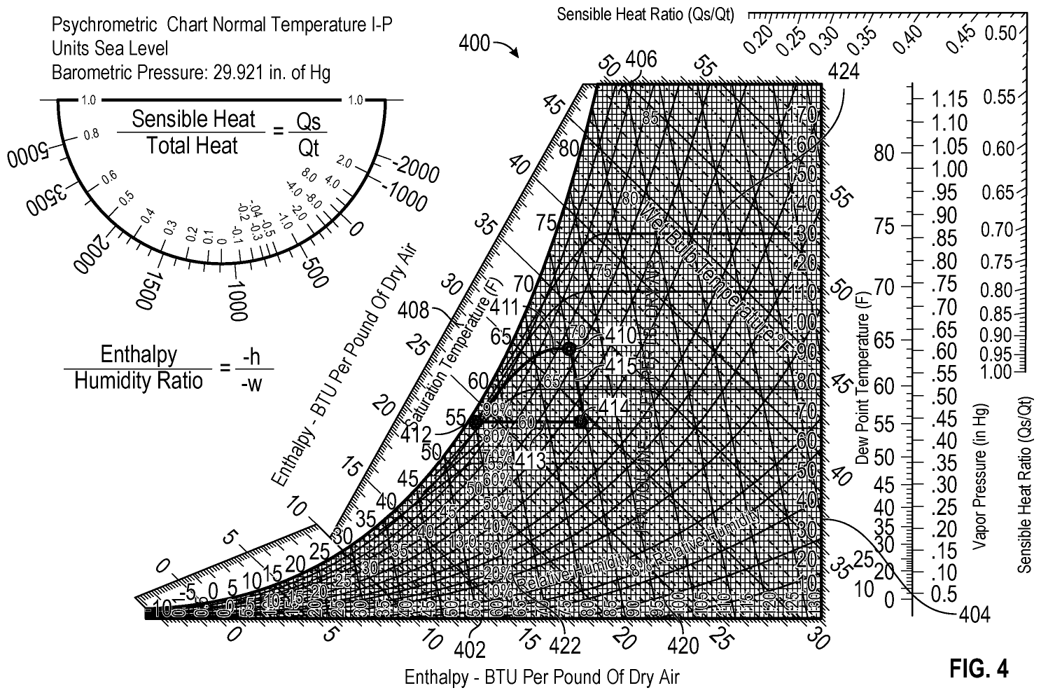

FIG. 4 illustrates psychrometric chart 400, according to an embodiment of the present disclosure.

Psychrometric chart 400 plots enthalpy in BTU per pound of dry air on horizontal x-axis 402, and dew point temperature in degrees Fahrenheit, vapor pressure in inches of mercury and sensible heat ratio Qs/Qt on vertical y-axis 404. Saturation temperature 408 is shown. The lines of relative humidity 420, 14.0 volume cutoff per dry air 422 and wet bulb temperature in degrees Fahrenheit 424 are illustrated. Points 410, 412 and 414 are shown. The psychrometric chart 400 may be used for any size grow space and any quantity of plants in the grow space. The psychrometric chart is used to show any relationship between moisture, temperature and pressure.

When FIG. 2, FIG. 3 and FIG. 4 are discussed together, it is apparent that as shown on psychrometric chart 400, from point 414 to 410, the plants in a grow space produce moisture, thereby driving up, or increasing, the moisture level in the grow space.

An analysis shows that from an initial temperature, point 410, cooling air is provided to the grow space. The sensible heat line runs parallel to the point 412. Moisture is pulled out during the cooling, as shown by line 411. Once the cooling and moisture removal reach a certain level, the temperature matches the point 412 (i.e., a dewpoint) of the grow space.

Once the point 412 is reached, there is no longer a need to pull additional moisture from the grow space. Recycle reheat coil 164, 214 is then operated to receive hot water from the condenser coil 148, 208. The hot water received at the recycle reheat coil 164, 214 is a result of the cooling shown by line 411 that reduces the temperature in the grow space from point 410 to point 412.

The temperature of the grow space is increased from point 412 to point 414, via line 413, by passing the airflow over recycle reheat coil 164, 214 and then into the grow space.

The “cooling” and “reheating” process can be repeated continuously over a desired number of cycles. The relative temperature, moisture levels and relative humidity can be adjusted based on the conditions of the grow space

Point 412 is selected by a user, or otherwise established as an input to a controller, such as ECU, described herein. Point 410 represents an initial temperature and an initial dewpoint. As the temperature decreases from the initial temperature at point 410, a second dewpoint is reached at point 412. As see in psychrometric chart 400, the point 412, which is a second dew point, is at a lower temperature, also shown by point 412 on psychrometric chart 400.

Thus, point 412 shows that the optimal, or desired, dewpoint is reached, but the temperature at point 412 is not optimal. Thus, the temperature is raised by the introduction of reheat, as shown by the transfer to point 414 on psychrometric chart 400.

To create or maintain optimal temperature and moisture, a graph such as 400 is useful, since lowering the temperature to reach the optimal dewpoint results in a cooling of the grow space, which then is reheated. The reheating, using recycle reheat coil 164, 214, reduced the relative humidity.

The cycle of cooling, dehumidifying and reheating is often affected by heat generated from lights in the grow space as well as moisture produced by plants in the grow space. The conditions of the grow space, light, heat and moisture, are usually changing, thus repeating the cooling and reheating cycles using point on a chart, such as psychrometric chart 400 is useful to re-calibrate the grow space conditions based on updated conditions.

The conditions of a grow space can change based, at least in part, on lighting conditions, amount of moisture in the grow space, due to water used for watering plant material and/or moisture produced by plant material and quantity of plant material in the grow space. The amount of plant material is accounted for utilizing the cooling and reheating described herein. The quantity of plant material will affect the cooling and reheating cycles as described in reference to the figures, such as FIG. 4 described herein.

One way to achieve the thermal energy transfer is to use glycol as a thermal energy transfer agent between the recycled reheat coil 214 and condenser 208.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

Application of the laws of thermodynamics shows that, for example using a “per unit” example, the total heat energy produced by cooling from 410 to 412 is assigned 1.0 units. Heat from the compression (308) adds an addition 0.3. The reheat energy is 0.4. Thus, the acquired thermal energy during the cooling and compression produces a surplus of thermal energy after the reheat, i.e., 1.3 units produces −0.4 units used during reheat.

FIG. 5 illustrates an example of airflow 500, according to an embodiment of the present disclosure. Airflow 500 is described as three points 502, 504 and 506, respectively. A cooling coil 514 (e.g., condenser coil 148, 208) is disposed between point 1 502 and point 2 504. A sensible heater unit 516 (e.g., recycle reheat coil 164, 214) is disposed between point 2, 504 and point 3 506. Sensible energy is a temperature value that is obtained from a thermometer while latent energy indicates a moisture content and can be measured using a barometer or other moisture content measuring device.

The process illustrated in FIG. 5 shows that air entering cooling coil 514 has certain characteristics, the air exiting cooling coil 514 and entering sensible heater unit 516 has different characteristics, and the air exiting sensible heater unit 516 has the desired characteristics.

Point 1 502 shows parameters 508 that describe the characteristics of the air entering the cooling/reheat system. Specifically, the air entering cooling coil 514 at point 502 has the following parameters 508: airflow 1,000 cfm, dry bulb temperature 77° F., wet bulb temperature 68.4° F., relative humidity (RH) 65.0%, humidity 90.7 gr/lb (grains/pound), enthalpy 32.7 Btu/lb, and dew point 64.3° F.

Cooling coil 514 includes parameters 518. These parameters 518 indicate what happens to the incoming air as a result of interacting with the cooling coil 514. These include total energy −38,516 Btu/hr, sensible energy −21,500 Btu/hr, latent energy −17,016 Btu/hr, sensible heat ratio 0.558, moisture difference −15.5 lb/hr and −1.9 gal/hr. Thus, cooling coil 514 removes heat from the airflow.

Point 2 504 shows parameters 510 that describe the characteristics of the air exiting the cooling coil 514. These parameters (or characteristics) 510 include airflow 1,000 cfm, dry bulb temperature 57.0° F., wet bulb temperature 56.1° F., relative humidity (RH) 95.0%, humidity 66.0 gr/lb, enthalpy 23.9 Btu/lb, and dewpoint temperature 55.6° F.

Sensible heating unit 516 has sensible heating characteristics, or parameters, 520. The characteristics, or parameters, 520 include total energy 24,616 Btu/hr, sensible energy 24,616 Btu/hr, latent energy 0 Btu/hr, sensible heat ratio 1.000, moisture difference 0.0 lb/hr and 0.0 gal/hr.

Point 3 506 shows parameters 512 that describe the characteristics of the air exiting the sensible heater unit 516. These parameters 512 include airflow 1,000 cfm, dry bulb temperature 79.0° F.; wet bulb temperature 64.1° F., relative humidity (RH) 44.5%, humidity 66.0 gr/lb, enthalpy 29.3 Btu/lb, and dewpoint 55.6° F.

As shown in FIG. 5, the characteristics of air in a grow space can be cooled via cooling coil 514 and then reheated using a sensible heater unit 516. This process shows that the reheat portion offsets any undesired, or unwanted, cooling.

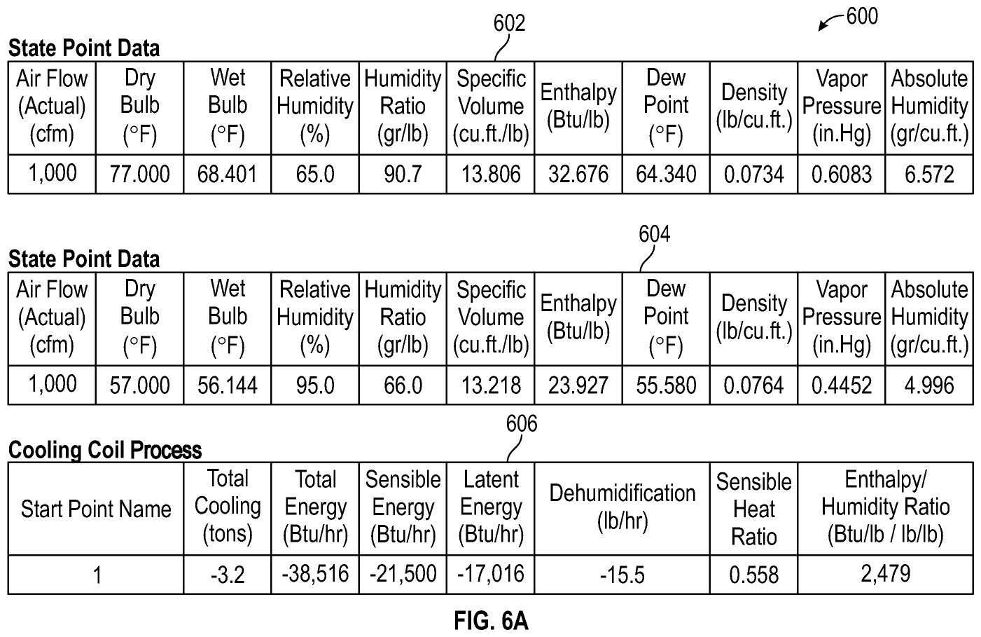

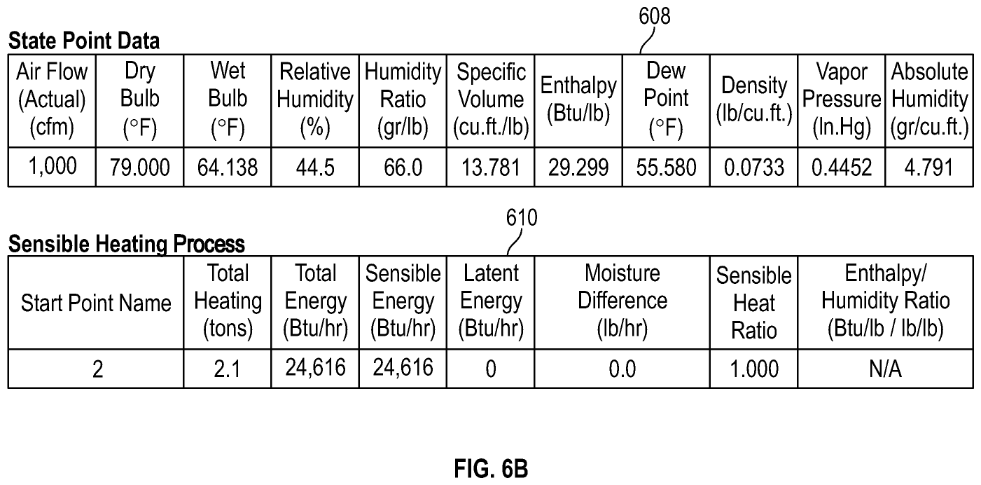

FIGS. 6A and 6B illustrate an example of a state point and process report 600, according to an embodiment of the present disclosure. The state point and process report 600 includes state point data table 602, state point data table 604, cooling coil process table 606, state point data table 608 and sensible heating process table 610.

State point data table 602 includes: airflow (actual) is 1,000 cfm, dry bulb temperature is 77.000° F., wet bulb temperature is 68.401° F., relative humidity is 65%, humidity ratio is 90.7 gr/lb, specific volume is 13.806 cu. ft./lb, enthalpy is 32.676 Btu/lb, dew point is 64.340° F., density is 0.0734 lb/cu.ft., vapor pressure is 0.6083 in. Hg, and absolute humidity is 6.572 gr/cu.ft.

State point data table 604 includes airflow (actual) is 1,000 cfm, dry bulb temperature is 57.000° F., wet bulb temperature is 56.144° F., relative humidity is 95%, humidity ratio is 66.0 gr/lb, specific volume is 13.218 cu. ft./lb, enthalpy is 23.927 Btu/lb, dew point temperature is 55.580° F., density is 0.0764 lb/cu.ft., vapor pressure is 0.4452 in. Hg, and absolute humidity is 4.996 gr/cu.ft.

Cooling coil process table 606 shows that at start point name 1: total cooling is −3.2 tons, total energy is −38,516 Btu/hr, sensible energy is −21,500 Btu/hr, latent energy is −17,016 Btu/hr, dehumidification is −15.5 lb/hr, sensible heat ratio is 0.558, and enthalpy/humidity ratio is 2,479 Btu/lb/lb/lb.

State point data table 608 includes: airflow (actual) is 1,000 cfm, dry bulb temperature is 79.000° F., wet bulb temperature is 64.138° F., relative humidity is 44.5%, humidity ratio is 66.0 gr/lb, specific volume is 13.781 cu. ft./lb, enthalpy is 29.299 Btu/lb, dew point temperature is 55.580° F., density is 0.0733 lb/cu.ft., vapor pressure is 0.4452 in. Hg, and absolute humidity is 4.791 gr/cu.ft.

Sensible heating process table 610 shows that at start point name 2: total heating is 2.1 tons. total energy is 24,616 Btu/hr, sensible energy is 24,616 Btu/hr, latent energy is 0 Btu/hr, moisture difference is 0.0 lb/hr, sensible heat ratio is 1.000, and enthalpy/humidity ratio is not applicable.

As shown in FIGS. 6A and 6B, the heat energy is removed during the cooling process and reheat occurs during the sensible heating process. The sensible heat ratio in 610 is 1.000 and the moisture difference is 0.0. Also, there is zero latent energy in the sensible heating process.

Another embodiment may be described as a system and method comprising three fluid/gas paths, i.e., refrigerant path, fluid (e.g., water, glycol, etc.) path, and air path. These three paths have been described in FIG. 2 herein.

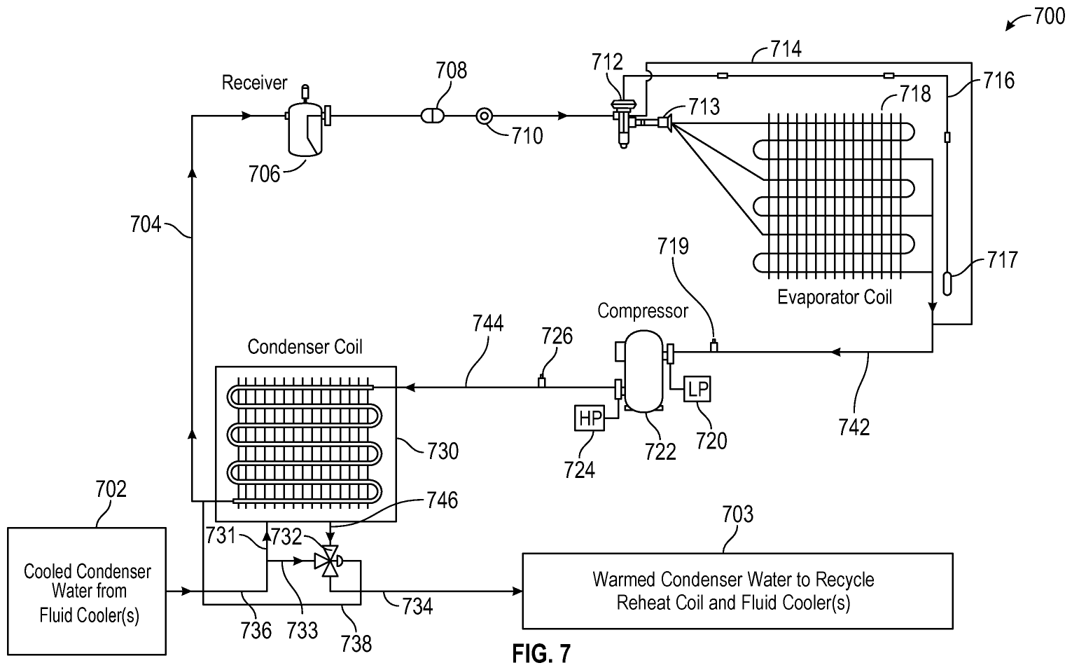

FIG. 7 depicts refrigerant loop (or system) 700, in accordance with an embodiment of the present disclosure.

Generally, includes certain of the components illustrated in FIG. 1, including condenser coil 730, head pressure control valve 732, receiver 706, evaporator coil 718 and compressor 722, as well as other pumps, valves, switches and components (renumbered for convenience). In many embodiments, the components are controlled by a controller, such as a PLC, while in other embodiments, the components may be mechanically controlled and/or pressure activated.

Refrigerant loop 700 receives cooled condenser water 702 from fluid coolers 102, 104, which is provided to condenser coil 730 via line 736 as a cooling medium. Similarly, refrigerant loop 700 sends warmed condenser water 703 from condenser coil 730 via line 734 to recycle reheat coil 164, 214 and fluid coolers 102, 104.

The condenser coil 730, as an example, may be a water or glycol cooled condenser coil. A head pressure control valve 732 is operatively coupled to the condenser coil 730. Some portion, or all, of the cooled condenser water 702 may be provided to the head pressure control valve 732 depending on the operation of the refrigerant loop 700. This is shown by line 736 branching between the condenser coil 730, shown by line 731 and head pressure control valve 732, shown by line 733.

Refrigerant output from condenser coil 730, via line 704, is provided to receiver 706, refrigerant dryer/strainer 708, sight glass 710 and thermal expansion valve 712. Distributor body 713 provides refrigerant from thermal expansion valve 712 to evaporator coil 718. Equalizer line 714 and conduit 716 to expansion valve feeder bulb 717 are also shown.

Refrigerant output from evaporator coil 718, and also equalizer line 714, is provided to compressor 722. Also shown in operation with compressor 722 is valve 719, which may be a Schrader valve, low pressure limit switch 720 and high-pressure limit switch 724. The low and high pressure limit switches 720, 724 may be used for pressure activated control of the system. In one embodiment, pressure activated control of the system may be independent of any other type of control. In another embodiment, pressure activated control may be operated in conjunction with one or more of mechanical control and/or PLC control.

Valve 726, such as a Shrader valve, is shown between compressor 722 and condenser coil 730.

Thermal energy is transferred as heated or warmed condenser water via line 734 to recycle reheat coil 164, 214 and fluid coolers 102, 104. Line 738 is a control line from line 704 to head pressure control valve 732, as discussed above.

Refrigerant loop 700 illustrates that air from a room, such as a grow room, or grow space, is being cooled and dehumidified across the evaporator coil 718. The refrigerant flowing through the evaporator coil 718 absorbs the heat from the air which lowers the air temperature down to the dewpoint and removes moisture from the air (e.g., heat of evaporation 306).

The refrigerant flows from the evaporator coil 718 into the compressor 722 where the refrigerant is compressed, thereby raising the pressure and temperature and adding thermal energy (e.g., heat of compression 308).

After leaving the compressor 722, the refrigerant flows into the condenser coil 730, which is a heat exchanger that has refrigerant on one side and water on the other. The refrigerant releases the thermal energy (e.g., total heat rejection 310) that the refrigerant absorbed from the air flowing across the evaporator coil 718 and the compression provided by compressor 722.

The refrigerant loop 700 is a cycle that continues as long as cooling and dehumidification is desired based, at least in part, on operating parameters of temperature and humidity of the grow space, or grow room, or other space. The components within refrigerant loop 700 may be mechanically controlled, pressure activated or controlled by a PLC controller as described herein, or any combination of mechanical control, pressure activation and/or PLC control.

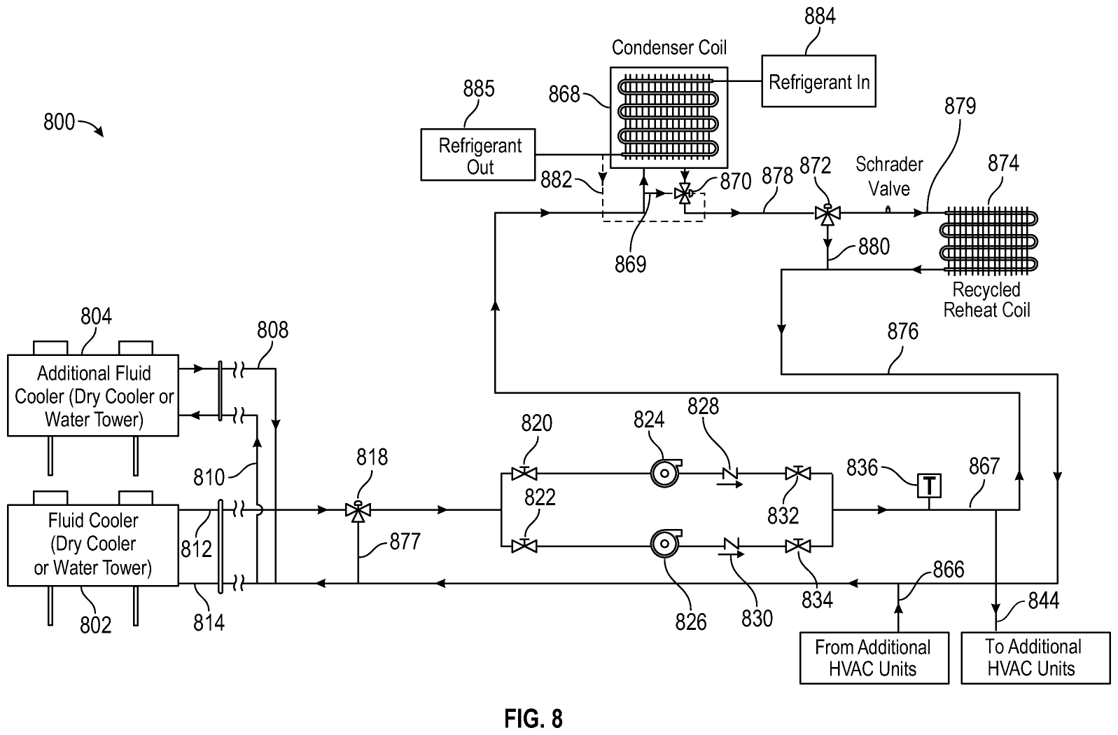

FIG. 8 shows a thermal energy transfer loop (or system) 800, in accordance with an embodiment of the present disclosure.

The fluid flow path includes fluid cooler 802, such as a dry cooler and/or water tower, and an additional fluid cooler 804, such as a dry cooler and/or water tower. The term “fluid” includes liquid, or gas or any combination of liquid and gas. Generally, water, glycol, or a mixture of water and glycol may be used.

Paths or lines 808, 810, 812 and 814 may be piping, tubing, such as PVC, or other plastic or flexible tubing that provide a path for fluid to enter or leave the associated fluid cooler 802, 804.

Recycled reheat three-way valve 818 generally provides control of flow between the components of thermal energy transfer loop 800, and generally provides fluid to lines 867 and 876. With respect to line 867, shut-off valves 820 and 822 are operatively coupled to primary pump 824 and standby pump 826, respectively. Check valve 828 is coupled to primary pump 824 and check valve 830 is coupled to standby pump 826. Associated shut-off valves 832 and 834 are also shown.

Temperature sensor circuit 836 is in the flow path as well as line 844 to additional HVAC units (not shown). While one temperature sensor circuit 836 is shown, any suitable number of temperature sensors may be used.

A portion of the fluid along line 867 may be provided to additional HVAC units by line 844, a portion of the fluid may be provided to head pressure control valve 870 by line 869, and a portion of the fluid along line 867 may be provided to condenser coil 868. The respective portions may vary from no fluid at all, some fluid, and all the fluid, depending on the operating condition.

Condenser coil 868 outputs the fluid to head pressure control valve 870. Condenser coil 868 also receives refrigerant via input 884 and outputs refrigerant via output 885. A portion of the output 885 is sent to head pressure control valve 870 via line 882.

The head pressure control valve 870 outputs the fluid to three-way control valve 872 via line 878. Three-way control valve 872 outputs the fluid to recycled reheat coil 874 via line 879 and to fluid coolers 802, 804 via lines 876, 810 and 814. Recycled reheat coil 874 output the fluid to line 876, which returns the fluid to fluid coolers 802, 804 via lines 810 and 814.

Fluid from additional HVAC units may be returned to fluid coolers 802, 804 via lines 866, 876, 810 and 814.

As shown in FIG. 8, fluid that has been cooled by fluid coolers 802, 84 is provided to condenser coil 868, where refrigerant warms the fluid through the condensation process described above. The warmed fluid flows from the condenser coil 868 to the three-way control valve 872.

If the temperature sensor(s), shown as single temperature sensor circuit, 836, indicate that the grow room temperature is too low the three-way control valve 872 is positioned by the controller to modulate the flow of fluid to the recycled reheat coil 874 that is located downstream in the airflow from the evaporator coil (i.e., evaporator coil shown in FIG. 7).

Air flowing over the recycled reheat coil 874 is heated and returned to the grow room, as shown as airflow 236(b) in FIG. 2 herein.

The three-way control valve 872 is positioned such that only the desired amount of warm fluid flow is directed to the recycled reheat coil 874, while the remaining warm fluid flow is diverted to the fluid coolers 802, 804, where the heat in the warmed fluid is released to the surrounding atmosphere.

The fluid then flows through the recycled reheat three-way valve 818, which is positioned by the PLC controller to maintain a setpoint fluid temperature to ensure that fluid temperature is sufficiently high enough to provide sufficient reheat year round (especially important in colder climates).

The fluid then enters the pumps 824, 826 that provide the pressure differential that keeps the water flowing throughout the thermal energy transfer loop 800.

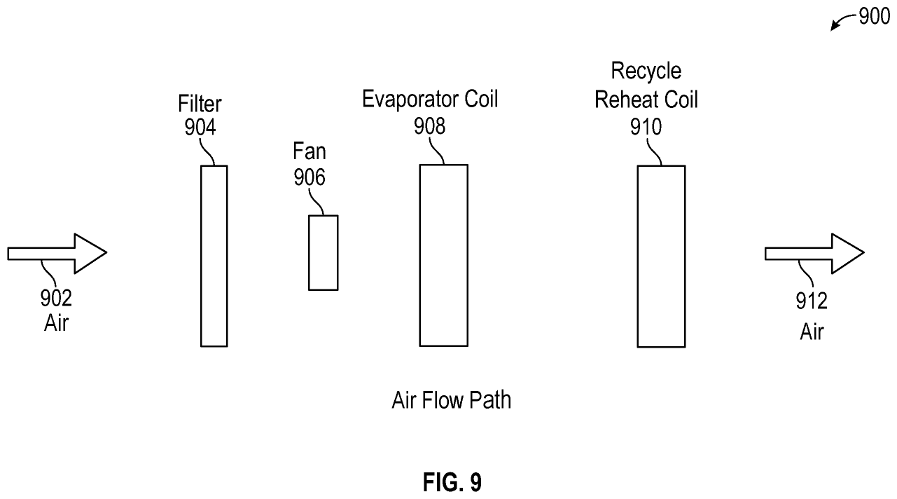

FIG. 9 shows an embodiment 900 of an airflow path and associated components. As shown in FIG. 9, air 902 from the grow space is filtered by filter 904. One or more fan(s) 906 blows the air from the filter 904 over evaporator coil 908. The air is then passed through a recycle reheat coil 910. Air 912 exits the recycle reheat coil 910 and into the grow space.

The fans 906 draw the air 902 from the grow space. The air 902 flows through the filter 904 where it is cleaned of particulate and then flows across the evaporator coil 908. As the air flows across the evaporator coil 908 it is cooled to the dewpoint at which point the air begins releases moisture (dehumidification). The condensed water flows down the recycle reheat coil 910 into a drain pan (not shown) where it is drained from the unit. The air then flows across the recycle reheat coil 910 where it is reheated back to the room temperature setpoint.

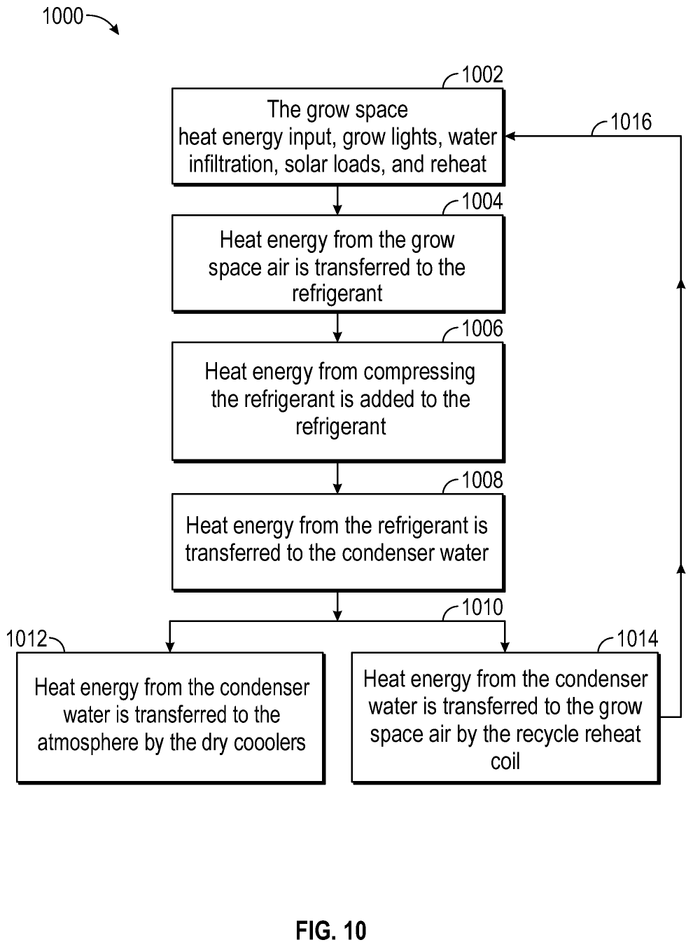

FIG. 10 depicts energy flow diagram 1000, according to an embodiment of the present disclosure.

The energy flow path begins with a grow space condition of temperature and relative humidity 1002. This grow space includes sources of heat such as: heat energy input; grow lights; water infiltration; solar loads; and reheat.

At least a portion of the heat energy in the air of the grow space (e.g., produced by a combination of grow light heat, water infiltration, solar loads, reheat, etc.) is removed by, and transferred to, the refrigerant in evaporator coil 718, as shown by 1004. This is the heat of evaporation 306.

Compression of the refrigerant by compressor 722 adds heat energy to the refrigerant, as shown by 1006. This is the heat of compression 308.

At least a portion of the heat energy from the refrigerant is then removed by, and transferred to, the condenser water in condenser coil 730, as shown in 1008. This it the total heat rejection 310.

A portion of the heat energy absorbed by the condenser water is released to the atmosphere, as shown by 1012, and a portion of the heat energy absorbed by the condenser water is released to the grow room air (i.e., “reheat” energy) via the recycle reheat coil 874, as shown by 1014.

The “reheat” energy is transferred back to the grow room, or grow space, as shown by 1016 leading to 1002.

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

All documents mentioned herein are hereby incorporated by reference in their entirety. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus and device may be used interchangeably in this text.

The above systems, devices, methods, processes, and the like may be realized in hardware, software, or any combination of these suitable for a particular application. The hardware may include a general-purpose computer and/or dedicated computing device.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another implementation, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of this disclosure and are intended to form a part of the disclosure as defined by the following claims, which are to be interpreted in the broadest sense allowable by law.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A system for a grow space, comprising:
a refrigerant loop, including:
a compressor configured to circulate refrigerant;
a condenser coil having a refrigerant side coupled to the compressor and a coolant side;
an evaporator coil, coupled to the compressor and the refrigerant side of the condenser coil, configured to cool and dehumidify a supply airflow to the grow space;
a thermal energy transfer loop, including:
a pump, coupled to the coolant side of the condenser coil, configured to circulate water;
a fluid cooler coupled to the pump;
a reheat coil, coupled to the fluid cooler, configured to warm the supply airflow downstream of the evaporator coil; and
a controller, coupled to a control valve having an input coupled to the coolant side of the condenser coil, a first output coupled to the reheat coil and a second output coupled to the fluid cooler, configured to:
modulate a flow of water to the reheat coil and the fluid cooler when a dew point temperature of ambient air in the grow space is less than a desired dew point temperature by a predetermined magnitude.

2. The system of claim 1, where:
the supply airflow has an initial dewpoint temperature upstream of the evaporator coil, an intermediate dewpoint temperature between the evaporator coil and the reheat coil, and a final dewpoint temperature downstream of the reheat coil;
a difference between the initial dewpoint temperature and the final dewpoint temperature is about 10° F.;
a difference between the initial dewpoint temperature and the intermediate dewpoint temperature is about 10° F.; and
a difference between the intermediate dewpoint temperature and the final dewpoint temperature is about 0° F.

3. The system of claim 2, where the initial dewpoint temperature is between 60° F. and 70° F., the intermediate dewpoint temperature is between 50° F. and 60° F., and the final dewpoint temperature is between 50° F. and 60° F.

4. The system of claim 2, where:
the supply airflow has an initial dry bulb temperature upstream of the evaporator coil, an intermediate dry bulb temperature between the evaporator coil and the reheat coil, and a final dry bulb temperature downstream of the reheat coil;
a difference between the initial dry bulb temperature and the final dry bulb temperature is less than 5° F.;
a difference between the initial dry bulb temperature and the intermediate dry bulb temperature is about 20° F.; and
a difference between the intermediate dry bulb temperature and the final dry bulb temperature is about 20° F.

5. The system of claim 4, where the initial dry bulb temperature and the final dry bulb temperature are between 75° F. and 80° F.

6. The system of claim 4, where:
the supply airflow has an initial wet bulb temperature upstream of the evaporator coil, an intermediate wet bulb temperature between the evaporator coil and the reheat coil, and a final wet bulb temperature downstream of the reheat coil;
a difference between the initial wet bulb temperature and the final wet bulb temperature is less than 5° F.;
a difference between the initial wet bulb temperature and the intermediate wet bulb temperature is less than 15° F.; and
a difference between the intermediate wet bulb temperature and the final wet bulb temperature is less than 10° F.

7. The system of claim 6, where the initial wet bulb temperature and the final wet bulb temperature are between 60° F. and 70° F.

8. The system of claim 6, where:
the supply airflow has an initial relative humidity upstream of the evaporator coil, an intermediate relative humidity between the evaporator coil and the reheat coil, and a final relative humidity downstream of the reheat coil;
a difference between the initial relative humidity and the final relative humidity is about 20%;
a difference between the initial relative humidity and the intermediate relative humidity is about 30%; and
a difference between the intermediate relative humidity and the final relative humidity is about 50%.

9. The system of claim 8, where the initial relative humidity is between 60% and 70%, the intermediate relative humidity is between 90% and 100%, and the final relative humidity is between 40% and 50%.

10. The system of claim 8, where:
the supply airflow has an initial specific humidity upstream of the evaporator coil, an intermediate specific humidity between the evaporator coil and the reheat coil, and a final specific humidity downstream of the reheat coil;
a difference between the initial specific humidity and the final specific humidity is between 20 gr/lb and 30 gr/lb;
a difference between the initial specific humidity and the intermediate specific humidity is between 20 gr/lb and 30 gr/lb; and
a difference between the intermediate specific humidity and the final specific humidity is about 0 gr/lb.

11. A system for a grow space, comprising:
a pump, coupled to a coolant side of a condenser coil, configured to circulate water, the condenser coil having a refrigerant side and the coolant side;
a fluid cooler coupled to the pump;
a reheat coil, coupled to the fluid cooler, configured to warm a supply airflow downstream of an evaporator coil that is configured to cool and dehumidify the supply airflow to the grow space; and
a controller, coupled to a control valve having an input coupled to the coolant side of the condenser coil, a first output coupled to the reheat coil and a second output coupled to the fluid cooler, configured to:
modulate a flow of water to the reheat coil and the fluid cooler when a dew point temperature of ambient air in the grow space is less than a desired dew point temperature by a predetermined magnitude.

12. The system of claim 11, where:
the supply airflow has an initial dewpoint temperature upstream of the evaporator coil, an intermediate dewpoint temperature between the evaporator coil and the reheat coil, and a final dewpoint temperature downstream of the reheat coil;
a difference between the initial dewpoint temperature and the final dewpoint temperature is about 10° F.;
a difference between the initial dewpoint temperature and the intermediate dewpoint temperature is about 10° F.; and
a difference between the intermediate dewpoint temperature and the final dewpoint temperature is about 0° F.

13. The system of claim 12, where the initial dewpoint temperature is between 60° F. and 70° F., the intermediate dewpoint temperature is between 50° F. and 60° F., and the final dewpoint temperature is between 50° F. and 60° F.

14. The system of claim 12, where:
the supply airflow has an initial dry bulb temperature upstream of the evaporator coil, an intermediate dry bulb temperature between the evaporator coil and the reheat coil, and a final dry bulb temperature downstream of the reheat coil;
a difference between the initial dry bulb temperature and the final dry bulb temperature is less than 5° F.;
a difference between the initial dry bulb temperature and the intermediate dry bulb temperature is about 20° F.; and
a difference between the intermediate dry bulb temperature and the final dry bulb temperature is about 20° F.

15. The system of claim 14, where the initial dry bulb temperature and the final dry bulb temperature are between 75° F. and 80° F.

16. The system of claim 14, where:
the supply airflow has an initial wet bulb temperature upstream of the evaporator coil, an intermediate wet bulb temperature between the evaporator coil and the reheat coil, and a final wet bulb temperature downstream of the reheat coil;
a difference between the initial wet bulb temperature and the final wet bulb temperature is less than 5° F.;
a difference between the initial wet bulb temperature and the intermediate wet bulb temperature is less than 15° F.; and
a difference between the intermediate wet bulb temperature and the final wet bulb temperature is less than 10° F.

17. The system of claim 16, where the initial wet bulb temperature and the final wet bulb temperature are between 60° F. and 70° F.

18. The system of claim 16, where:
the supply airflow has an initial relative humidity upstream of the evaporator coil, an intermediate relative humidity between the evaporator coil and the reheat coil, and a final relative humidity downstream of the reheat coil;
a difference between the initial relative humidity and the final relative humidity is about 20%;
a difference between the initial relative humidity and the intermediate relative humidity is about 30%; and
a difference between the intermediate relative humidity and the final relative humidity is about 50%.

19. The system of claim 18, where the initial relative humidity is between 60% and 70%, the intermediate relative humidity is between 90% and 100%, and the final relative humidity is between 40% and 50%.

20. The system of claim 18, where:
the supply airflow has an initial specific humidity upstream of the evaporator coil, an intermediate specific humidity between the evaporator coil and the reheat coil, and a final specific humidity downstream of the reheat coil;
a difference between the initial specific humidity and the final specific humidity is between 20 gr/lb and 30 gr/lb;
a difference between the initial specific humidity and the intermediate specific humidity is between 20 gr/lb and 30 gr/lb; and
a difference between the intermediate specific humidity and the final specific humidity is about 0 gr/lb.
